(19) United States
(12) Patent Application Publication
(10) Pub. No.: US 2012/0120973 A1
(43) Pub. Date: May 17, 2012

(54) Laser Selector Mechanism

(75) Inventors: Theodore Bruce Ziemkowski, Windsor, CO (US); John Bonvallet, Boulder, CO (US); Conrad Proft, Loveland, CO (US)

(73) Assignee: Z-Image, LLC, Windsor, CO (US)

(21) Appl. No.: 13/295,060

(22) Filed: Nov. 12, 2011

Related U.S. Application Data
(63) Continuation-in-part of application No. 11/748,401, filed on May 14, 2007, now Pat. No. 7,663,091.
Application No. 11/748,401 is a continuation-in-part of application No. 12/557,956, filed on Sep. 11, 2009.
(60) Provisional application No. 60/800,157, filed on May 15, 2006.

(51) Int. Cl. H01S 3/13

(52) U.S. Cl. 372/29.02

(57) ABSTRACT

An amusement attraction may have a laser input device where a user may wave several fingers or make repeated motions to break a laser beam in a predefined pattern. The pattern may be recognized by a controller to perform a specific function. In one embodiment, a maintenance technician may use the input device to turn on or off certain lasers in a laser maze attraction. In another embodiment, a game player may use the input device to configure the game, change conditions of the game, or perform some other function.

### CROSS REFERENCE TO RELATED APPLICATIONS

This application claims priority to and benefit of U.S. Provisional Patent Application Ser. No. 60/800,157, filed May 15, 2006 by Ted Ziemkowski entitled “Laser Trapped, Timed, Challenge Attraction”, U.S. patent application Ser. No. 11/748,405, filed May 14, 2007 entitled “Laser Maze”, U.S. patent application Ser. No. 11/748,401, filed May 14, 2007 entitled “Laser Controller” and U.S. patent application Ser. No. 12/557,956 filed Sep. 11, 2009 entitled “Laser Safety Controller”, the entire contents of which are hereby expressly incorporated by reference.

### BACKGROUND

Many applications exist where humans may interact with lasers. Because lasers can generate large amounts of power, lasers can inflict harm to humans, especially to a person's vision. Lasers often have very low divergence and high coherence, which can cause retinal damage with exposure at even low power levels.

A safety class system is defined in ANSI Z136 and IEC 60825 and sets forth several classes of lasers for use in industry. The following descriptions of the various class designations are general in nature and are not meant to precisely explain the class designations defined in the ANSI and IEC standards, which may be updated from time to time.

In general, Class 1 lasers are defined to be safe under all conditions of normal use. For example, a continuous laser at 600 nm wavelength can emit up to 0.39 mW and may be considered a Class 1 laser. Other wavelength lasers may have higher or lower permitted power output to be considered Class 1, as different wavelength light is attenuated differently in the human eye.

In general, Class 2 lasers are more powerful than Class 1 lasers, but rely on a human's blink reflex to limit the exposure to less than 0.25 seconds and only apply to visible light lasers (400-700 nm). Class 2 lasers are generally limited to lmW continuous wave.

In general, a Class 3B laser is hazardous if the eye is exposed directly, but diffuse reflections such as from paper or other matte surfaces are generally not considered harmful. Within Class 3B, continuous lasers in the wavelength range from 315 nm to far infrared are limited to 0.5 W. For pulsed lasers between 400 and 700 nm, the limit is 30 mJ. Other limits apply to other wavelengths and to ultrashort pulsed lasers. Protective eyewear is typically used where direct viewing of a class 3B laser beam may occur. Class-3B lasers generally are equipped with a key switch and a safety interlock.

In general, a Class 3R laser is considered safe when handled carefully, with restricted beam viewing. The Maximum Permitted Exposure can be exceeded, but with a low risk of injury. Visible continuous lasers in Class 3R are typically limited to 5 mW. Other limits may apply to pulsed lasers and lasers in other wavelengths.

In applications where a laser beam is used for detection, higher powered lasers may be desired so that the laser beam may be more accurately and effectively sensed. However, the more powerful lasers can inflict harm.

Amusement attractions are entertaining and sometimes challenging games that bring out competitive and excited emotions from patrons. Haunted houses, laser tag games, and various arcade games and simulators are typical examples.

A successful attraction may appeal to potential patrons by being relatively easy to understand while offering a challenge to patrons. Lights, sounds, and other effects may be used to interest a potential patron and draw the patron to the attraction. From the operator's standpoint, a successful attraction may also be durable, easy to operate, easy to configure, and reliable.

### SUMMARY

An amusement attraction may have a laser input device where a user may wave several fingers or make repeated motions to break a laser beam in a predefined pattern. The pattern may be recognized by a controller to perform a specific function. In one embodiment, a maintenance technician may use the input device to turn on or off certain lasers in a laser maze attraction. In another embodiment, a game player may use the input device to configure the game, change conditions of the game, or perform some other function.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram of an embodiment showing an example of a basic system configuration.

FIG. 2 is a diagram of an embodiment showing an example of a dual laser system with discrimination.

FIG. 3 is a diagram of an embodiment showing an example of a network based laser system.

FIG. 4 is a flowchart illustration of an embodiment showing a general operation of a laser system.

FIG. 5 is a flowchart illustration of an embodiment showing a setup and turn on method for a laser system.

FIG. 6 is a flowchart illustration of an embodiment showing an operational mode method for a laser system.

FIG. 7 is a diagram of an embodiment showing an example of a laser maze attraction.

FIG. 8 is a plan view diagram of an embodiment showing an example of a circular laser maze.

FIG. 9 is a diagram of an embodiment showing an example of the functional portions of a laser maze system.

FIG. 10 is a flowchart illustration of an embodiment showing an example of a method for game operation.

FIG. 11 is a flowchart illustration of an embodiment showing an example of a logic for laser control.

FIG. 12 is a flowchart illustration of an embodiment showing a method for scanning a detector and controlling a laser.

FIG. 13 is a flowchart illustration of an embodiment showing a second method for scanning a detector and controlling a laser.

FIG. 14 is a flowchart illustration of an embodiment showing a method for programming lasers in a maintenance mode.

FIG. 15 is a flowchart illustration of an embodiment showing a method for using input from a detector during gameplay.

### DETAILED DESCRIPTION

Many types of amusements may use laser devices as sensors, obstacles, or for decoration. A laser input device may be activated by breaking a laser beam in a sequence of short breaks. This may be accomplished by passing several outstretched fingers across a laser beam, moving an arm through the laser beam repeatedly, or through some other movement.

A sensor on the laser device may detect that the beam is broken and determine an input command by the sequence of breaks and the timing of the breaks. Some embodiments may operate by determining an input from merely a number of breaks.

In one use scenario, a laser maze attraction may be configured by placing a laser controller in a maintenance or configuration mode. A technician may enter the maze and may be able to select lasers for various configuration options. One operation may be to select which lasers are turned on or off for different levels of a game.

In another use scenario, a game participant may configure the game by passing a number of fingers through a laser beam to select a level of play. In some cases, the game participant may pass fingers across a laser beam to enter a code during game play.

The laser system may operate with a class 2 laser operating at full power prior to breaking the beam. Once the beam is broken, the laser may reduce its operating power to that of a class 1 laser while waiting for the beam to be reestablished. In such a manner, the laser system may operate at a class 2 power level but reduce power so that humans cannot be harmed. In some embodiments, the laser may resume class 2 power levels when the laser beam is reestablished.

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

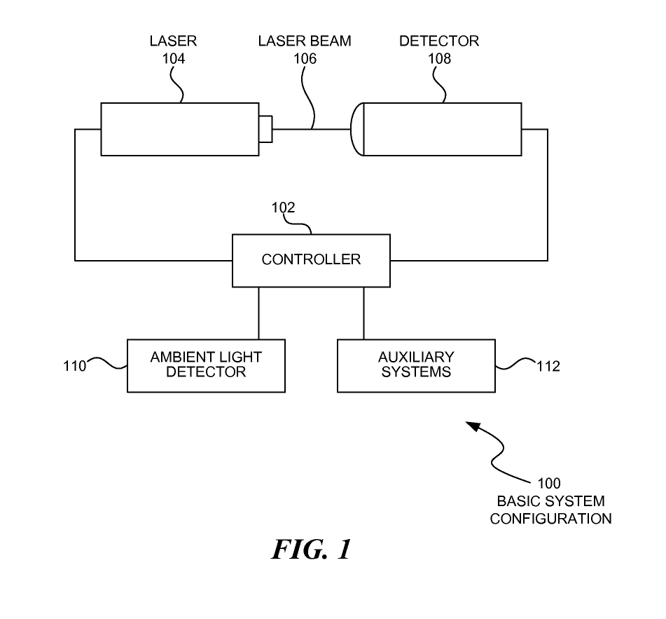

FIG. 1 is a diagram of an embodiment 100 showing a basic configuration of a laser and detector. Embodiment 100 is a simplified example of a system that might be used in detecting the presence of a person or object.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 100 has a controller 102 that may control a laser 104. The laser 104 may generate a laser beam 106 that is detected by the detector 108.

Lasers are known to potentially cause vision damage in humans. The controller 102 may operate the laser 104 at a power level that is potentially hazardous but without exposing a human to a hazardous level. This level of safety may be achieved in several manners. One manner may be to operate the laser beam 106 at a low power level if the laser beam 106 is not detected by the detector 108. Another manner may be to operate the laser 104 in a low power mode if the ambient light changes such that the ambient light may interfere with the detector 108.

During normal operation, the laser 104 may operate in high power mode when the detector 108 senses the laser beam 106. Otherwise, the laser 104 may be turned off or operated in a low power mode when the detector 108 does not detect the laser beam 106. Because there cannot be a human exposed to the laser beam 106 when the laser beam 106 is being received by the detector, operating in high power mode may still be safe for humans.

During alignment of the laser 104, the system may operate either in a high powered mode or a low powered mode. In a high powered mode, the system may potentially expose a human to the laser beam 106. Such a mode may be a maintenance mode or other special mode where a maintenance technician may wear safety glasses, be trained in laser hazards, or have other requirements for operating the laser 104. Some such systems may have interlocks or security features that permit trained technicians to operate the system in such a mode. Such a mode may operate at a Class 2, Class 3B, or Class 3R exposure level. After the alignment is complete and the detector 108 affirmatively detects the laser beam 106, the controller 102 may be activated and turn off the laser 104 in case of misalignment or if the laser beam is broken. In such a mode, the system may operate at a Class 1 or Class 2 exposure level.

During alignment of the laser 104, the system may operate in a low powered mode. In such a mode, the laser beam 106 may have a decreased signal until the detector 108 senses the laser beam 106. Once the detector 108 senses the laser beam 106, the controller 102 may turn the laser 104 to a high power mode. Such an alignment mode may be performed at safe exposure levels and may not require interlocks, specialized training, safety glasses, or other precautions for a high power laser system.

A laser controller may operate one or more lasers in a manner such that the lasers may limit human exposure to the lasers, but while operating the lasers in a high power mode during normal operation. The laser controller may operate the lasers in a high power mode when the laser beam is affirmatively detected by a sensor. When the sensor does not detect the laser beam, the laser is turned off or operated in a low power mode.

The system may enable Class 3B or Class 3R lasers to be operated in a Class 1 manner when the controller performs the controlling operations within a short period of time. For example, the system may operate a Class 3R laser as compliant with Class 1 when the controller can turn off or reduce the power level of the Class 3R laser within 0.25 seconds, depending on the laser wavelength.

A laser controller may protect a human during both startup and operational phases. During startup, the laser controller may limit laser operation in a lower power mode until a sensor detects the laser beam. After the laser beam is detected, the laser controller may then operate the laser in a high power mode. In general, the low power mode may be compliant with Class 1 while the high power mode may be a higher power level, such as Class 2, Class 3R, or Class 3B.

During operation, the laser controller uses a sensor to detect the laser beam. The sensor may receive the laser beam by being the endpoint of the laser beam. The sensor may be configured so that the laser beam, if broken or misaligned, is no longer sensed. The sensor is sensing the laser beam, the configuration ensures that the laser beam cannot be striking a human. If the laser beam is broken or misaligned, the laser controller may be configured to assume that the laser beam may strike a human and thus is operated in a low power manner, such as Class 1 or Class 2.

For example, the laser controller may be configured to sense a laser beam, and when the laser beam is broken, turn off the laser within a very short period of time or lower the laser power level to a safe level within the short period of time. In a typical embodiment, such a change may occur within 0.25 seconds, for example. Such a system may limit any potential human exposure to less than 0.25 seconds.

The laser controller may use an ambient light sensor to determine if the sensor would be capable of detecting the laser beam, and may also encode the laser beam with a signal to enable positive detection. In some such embodiments, two or more laser beams may be individually sensed and controlled using a single sensor.

Humans have a blink reflex that causes the eye to blink if exposed to a bright light. In general, the blink reflex occurs in approximately 0.25 seconds. Also, there is a human aversion response that causes a human to instinctively look away from a light source. Thus, if a relatively high powered laser such as a Class 2, Class 3B, or even Class 3R laser is turned off within 0.25 seconds, the human cannot have a higher exposure than a Class 1 laser device. Some embodiments may turn off the laser within 300 milliseconds, 270 milliseconds, 250 milliseconds, 200 milliseconds, or other lengths of time. In some cases, the length of potential exposure may be a function of the wavelength of the light beam, and the maximum exposure time may be higher or lower depending on the color of the laser beam.

Class 4 lasers are generally any type of laser that has greater than Class 3 power levels. In general, Class 4 lasers can often burn a human's skin and are generally not used in applications where humans may come into contact with the laser beam.

The laser and detector system of embodiment 100 may be used in many different applications for sensing the absence of an object. In some applications, that object being sensed may be a human. When the laser beam 106 is affirmatively sensed by the detector 108, the system can affirmatively detect that no object is blocking the laser beam 106 and thus can affirmatively detect the absence of an object. If the detector 108 does not detect the laser beam 106, the system may be misaligned, partially inoperable, or an object may be present.

Examples of the uses of embodiment 100 may be for detecting the presence of a human for security systems, light curtain safety applications, or for game applications. When the laser beam 106 is in the visible spectrum, the laser beam 106 may be a visible indicator that a security system is operating, a safety issue is nearby, or may serve as an obstacle in a game or other amusement attraction.

Embodiment 100 may operate by controlling the intensity of the laser beam 106. When the laser is initially turned on, the controller 102 may cause the laser 104 to turn on at a safe power level, such as a Class 1 power level. After the laser 104 is operational at a Class 1 level, the detector 108 may be queried to determine if the laser is detected. If the laser is detected, the controller 102 may cause the laser 104 to be operated at a higher power level, such as Class 2, Class 3R, or Class 3B. The controller 102 may be capable of detecting when the laser beam 106 is broken and turning the laser 104 to a lower power level. In some embodiments, the laser 104 may be turned off completely when the laser beam 106 is broken.

When operating the embodiment 100, the controller 102 may set a detection threshold for the detector 106 by reading or querying the input signal from the detector prior to turning on the laser 104. Such an initial query may be used to set an ambient light threshold for the detector 108. The ambient light threshold may be used as a limit by which the presence or absence of the laser beam 106 may be detected. A signal above the ambient light threshold may be interpreted as sensing the laser beam 106 whereas a signal below the ambient light threshold may be interpreted as not sending the laser beam 106.

An ambient light threshold may serve a function of setting the sensitivity of a detector based on the initial ambient light sensed by the detector. In cases where there is bright ambient light, the threshold may be high, while when there is little or no ambient light, the threshold may be low.

In some embodiments, the controller 102 may use an ambient light detector 110 to determine the ambient light threshold for the detector 108. The ambient light detector 110 may be any type of detector that may sense non-laser light that may be received by the detector 108. Some such embodiments may use a calibrated ambient light detector 110 to determine a threshold for the detector 108.

Some embodiments may use an ambient light detector 110 to adjust the ambient light threshold for the detector 108 periodically or in real time. In such an embodiment, a change in the light sensed by the ambient light detector 110 may cause the ambient light threshold for the detector 108 to be adjusted.

In many such embodiments, if the adjusted ambient light threshold is too high, the detector 108 may not be capable of detecting the laser beam 106 and, in such a case, the laser 104 may be turned off or operated at a safe power level. An example may be a situation where the embodiment 100 is designed to be operated in a room with no light or very little light. If a bright overhead light is turned on, the detectors may not have enough dynamic range to sense the laser beam 106 in full light. When the laser beam 106 cannot be affirmatively detected, the laser beam 106 may be operated at low power.

The laser 104 may be any type of laser that may be controlled by the controller 102. In general, the laser 104 may be configured to be turned on and off by the controller 102 and may also be configured to have an output power level controlled by the controller 102. In some embodiments, the controller 102 may not be able to turn the lasers on and off, but may be only capable of changing the power level of the lasers. In still other embodiments, the controller 102 may be capable of only turning the lasers on and off without adjusting the power level.

The laser 104 may be connected to the controller 102 by various mechanisms. In one embodiment, electrical wires may directly connect the laser 104 to the controller 102. Such connections may include power for the laser 104 as well as a mechanism to control output power. In some cases, the controller 102 may control the power output of the laser 104 by regulating the power supplied to the laser 104. In other cases, the controller 102 may control the power output of the laser 104 by controlling another input to the laser 104.

The detector 108 may also be connected to the controller 102 by various mechanisms. In one embodiment, electrical wires may directly connect the detector 108 to the controller 102. Such connections may include power for the detector 108. In some embodiments, such as embodiment 300 presented later in this specification, the laser 104 may be connected to and controlled by the controller 102 through a network connection.

The controller 102 may have connections to various auxiliary systems 112. The auxiliary systems 112 may provide input to the controller 102, such as to send signals to the controller 102 to start the laser 104, as well as receive output from the controller 102, such as to receive a signal when the laser beam 106 is interrupted.

In many embodiments, the controller 102 may also perform many other functions, such as setting off an alarm if a laser beam is broken, causing a machine to operate while the laser beam is detected, or performing other functions for a particular application.

The laser 104 may be any type of laser, including visible light lasers. Visible light lasers may include red lasers, green lasers, and other colored lasers.

The laser beam 106 may be transmitted through any medium. In many cases, the laser beam 106 may be transmitted at least in part through air. In some cases, the laser beam 106 may be transmitted through various conductors, including light pipes, fiber optics, and other conductors. Some embodiments may use mirrors, reflectors, or other optical components to position and direct the laser beam 106 from the laser 104 to the detector 108.

Embodiment 100 illustrates a system with one laser and one detector. Other embodiments may have multiple lasers and multiple receivers.

In some embodiments, the auxiliary systems 112 may include a person sensor. A person sensor may be a motion detector, infrared sensor, or some other sensor that may sense that a person is present or nearby. When a person is sensed, the controller 102 may power on the laser 104 only to a low power mode, such as a safe mode. In some embodiments, the person sensor may be used to limit the power level of the laser 104 at a safe level, and the power level may be raised to a higher power level only when the detector 108 affirmatively senses the laser beam 108.

For the purposes of this specification and the claims, a “controller” may be a single processor controller or a combination of multiple processors. In some cases, a portion of the functions of a controller may be performed by one processor, programmable logic device, gate array, logic device, state machine, ladder logic controller, personal computer, microprocessor, hardwired logic device, or other controller element while other functions are performed by a different controller element. For example, a personal computer may be used to perform some functions such as a user interface or network connectivity while another controller element with a separate processor performs the laser control and sensing functions. The “controller” as used in this specification and claims may be of any architecture adapted to perform the functions described. Any reference to a controller architecture is for illustrative purposes and is not meant to be limiting.

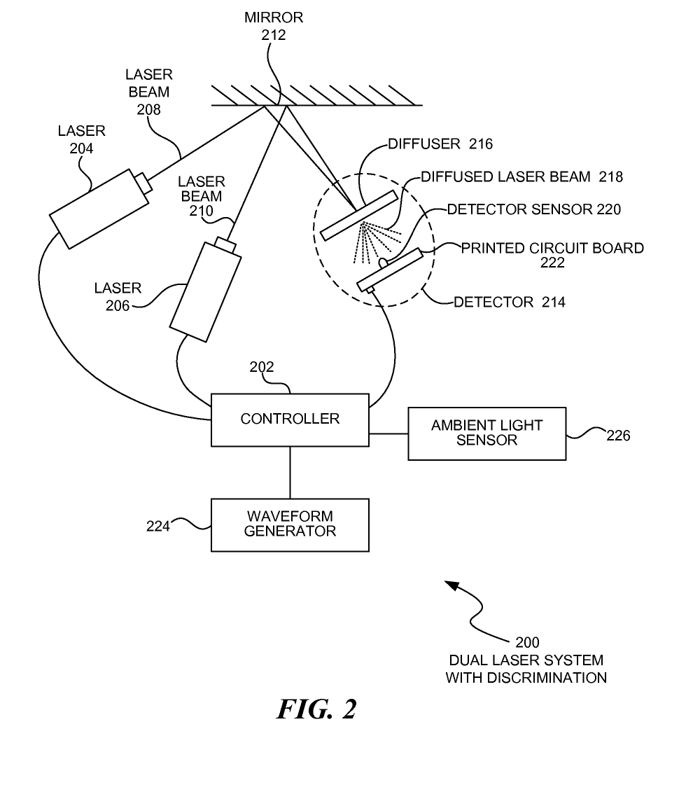

FIG. 2 is a diagram of an embodiment 200 showing a system with two lasers and a single detector. Embodiment 200 is a simplified example of a system that might be used when multiple laser beams are used in a single application.

The diagram of FIG. 2 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 illustrates a dual laser system that uses a single detector. Each laser may have a waveform applied to the respective laser beam so that the controller 202 may be able to sense and control each laser beam independently.

A controller 202 may control lasers 204 and 206, which may transmit laser beams 208 and 210, respectively. The laser beams 208 and 210 are illustrated as being reflected off of a mirror 212 and are detected by a detector 214.

When the laser beams 208 and 210 are being transmitted, the controller 202 may define a waveform that may be coupled to the transmission of a specific laser. The waveform may be an alternating current or other waveform, with different waveforms being coupled to each laser beam. The detector 214 or the controller 202 may be used to discriminate between the two laser beams and determine which one or both of the lasers are successfully transmitting a laser beam to the detector 214.

The laser configuration of embodiment 200 illustrates laser beams being reflected off a mirror. In many applications, laser beams may be reflected off of one or more mirrors to direct the laser beam across an area to be sensed. In some cases, a laser beam may be redirected many times through various mirrors, light pipes, fiber optics, and other optical conduits to cover a target area. Different embodiments may have different mirror configurations.

The detector 214 may be made up of a diffuser 216 that may diffuse the incoming laser beams 208 and 210 to create a diffused laser beam 218. A detector sensor 220 may be mounted on a printed circuit board 222, which may provide additional electronics or connections that interact with the controller 202.

The detector 214 and the various components that make up the detector 214 are examples of a mechanism that may operate as a detector. Other detector configurations and various detector technologies may be employed to function as the detector 214.

The controller 202 may have an ambient light sensor 226 that may operate as ambient light sensor 110 that was described in embodiment 100.

The waveform generator 224 may generate waveforms that are coupled to the respective laser beams. In one example, an alternating current waveform of 1 kHz may be used for one laser beam while a second laser beam may be coupled to a 1.4 kHz waveform. Some embodiments may use waveforms greater than 1 kHz, such as waveforms greater than 10 kHz, 30 kHz, 50 kHz, 100 kHz, 1 MHz, 10 MHz, or higher. Other embodiments may use waveforms less than 1 kHz, such as 500 Hz, 100 Hz, 60 Hz, 50 Hz, or lower.

In some embodiments, the detector sensor 220 may detect light in a wide variety of frequencies and may generate a signal proportional to the white light received by the sensor 220. In other embodiments, the detector sensor 220 may be tuned or filtered to receive light in a range of wavelengths that include the wavelengths of the lasers 204 and 206.

Some embodiments may use the same colored lasers for lasers 204 and 206, while other embodiments may have different colored lasers.

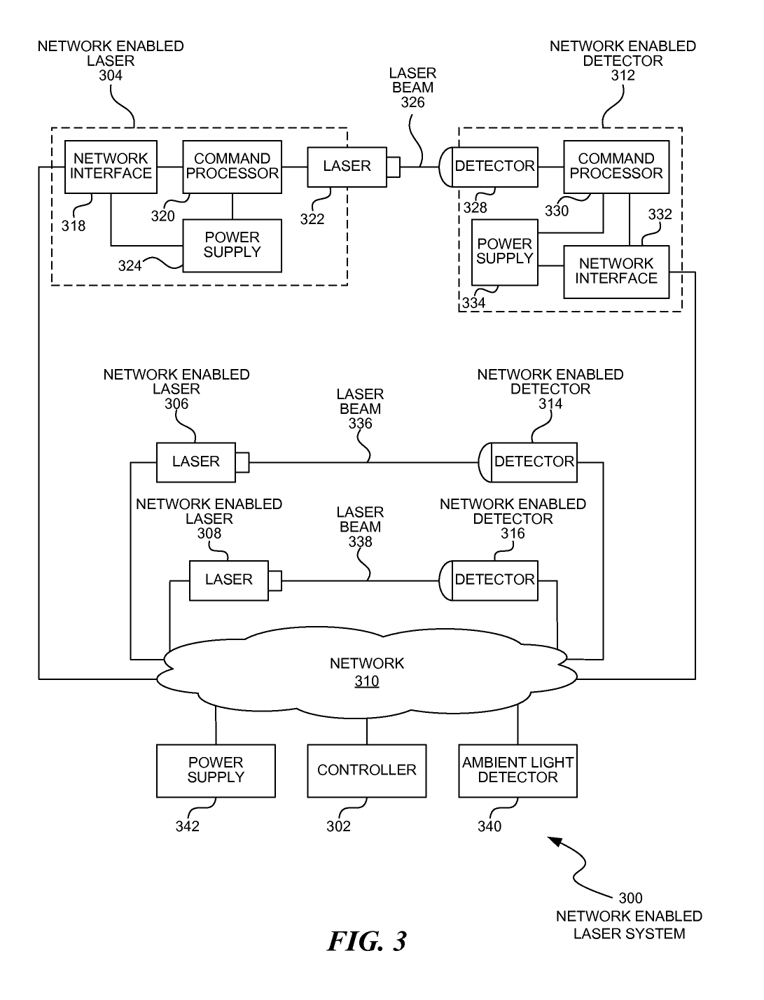

FIG. 3 is a diagram of an embodiment 300 showing a system with network connected lasers and detectors. Embodiment 300 is a simplified example of a system that might be used in a security system, laser maze game attraction, or other application where multiple lasers may be used to sense objects or humans.

The diagram of FIG. 3 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 300 has a controller 302 that may control several network enabled lasers 304, 306, and 308, and receive input signals from network enabled detectors 312, 314, and 316. The lasers may produce laser beams 326, 336, and 338, respectively. The communication and control between the controller 302 and the various lasers and detectors may be through a network 310.

The network 310 may be any network through which the controller 302 may communicate with the lasers and detectors. In one embodiment, an Internet Protocol communication layer may be operated over an Ethernet hardware connection as the network 310.

A network enabled laser 304 may comprise a network interface 318, a command processor, and the laser 322. The network enabled laser 304 may also include a power supply 324. The network enabled laser 304 may be assembled and mounted within a single enclosure as a single device in some embodiments, while in other embodiments, the network enabled laser 304 may be housed in multiple enclosures or devices.

Similarly, the network enabled detector 312 may include a detector 328, a command processor 330, a network interface 332 and a power supply 334. The network enabled detector 312 may be housed in a single enclosure as a single device or may consist of several devices operating together.

The command processor 320 within the laser and command processor 330 within the detector may send and receive commands from the controller 302. The command processors may be controllers dedicated to the respective laser or detector in some embodiments.

In some embodiments, the network 310 may be capable of distributing power to the lasers and/or the detectors. In an Ethernet embodiment, one such technology may be Power over Ethernet (PoE). In such a case, a single power supply 342 may provide power to the network and the network may distribute power to the various lasers and detectors. In other embodiments, the lasers and detectors may have separate power supplies.

Similar to embodiments 100 and 200, embodiment 300 may include an ambient light detector 340. The ambient light detector 340 may operate in a similar manner as ambient light detector 110 of embodiment 100.

In the embodiment 300, the controller 302 may operate the various lasers by detecting the respective laser beams and turning off the lasers or switching to a low power mode when the laser beam is not detected.

The controller 302 may operate so that a change to one laser beam will enable that laser to be turned off while allowing the other lasers to continue to operate in high power mode. In some embodiments, the controller 302 may have a routine to assign specific detectors with specific lasers so that the lasers may be controlled independently.

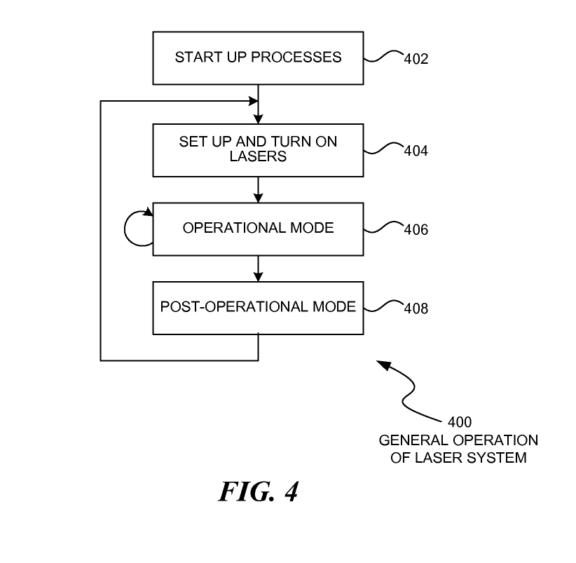

FIG. 4 is a flowchart illustration of an embodiment 400 showing a general method for operating a laser detection system.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 illustrates the general process of operating a laser. Various startup processes may be performed in block 402, then the setup and turn on process in block 404 may illuminate the lasers. When the lasers are illuminated properly in block 404, the process may proceed into an operational mode 406. When a laser beam is broken or other condition occurs, the operation may proceed to a post operational mode in block 408.

Embodiment 400 may be used in a security system, for example. During the startup processes of block 402, the security system may become armed. Through the setup and turn on operation of block 404, the lasers and detectors may be turned on, checked, and configured for operation. During the operational mode of block 406, the detectors may be continually polled to determine if a laser beam has been broken. In some embodiments, a processor with an interrupt mechanism may be used to sense that a laser beam may be broken. If a laser beam has been broken, or for some other reason, the post operational mode may be initiated. In the example of a security system, a post operational mode in an emergency situation may involve alerting a security guard, setting off an alarm, locking certain doors, or other actions in response to the detection. A normal post operational mode may be used to shut down the security system in an orderly fashion, for example, when a business secured by the detection system is opened for business after being closed over a weekend.

In another use scenario, embodiment 400 may illustrate a use for a laser maze game or amusement attraction. During the startup process of block 402, a user may validate payment and otherwise cause the game to begin. After starting the lasers in block 404, the game may enter an operational mode in block 406 during gameplay. The gameplay may end due to a timeout, an error, or other reason and enter a post operational mode in block 408 where the user's score may be tabulated and displayed.

Embodiments 500 and 600 illustrate detailed examples of processes that may be performed during the operations of blocks 404 and 406 of embodiment 400.

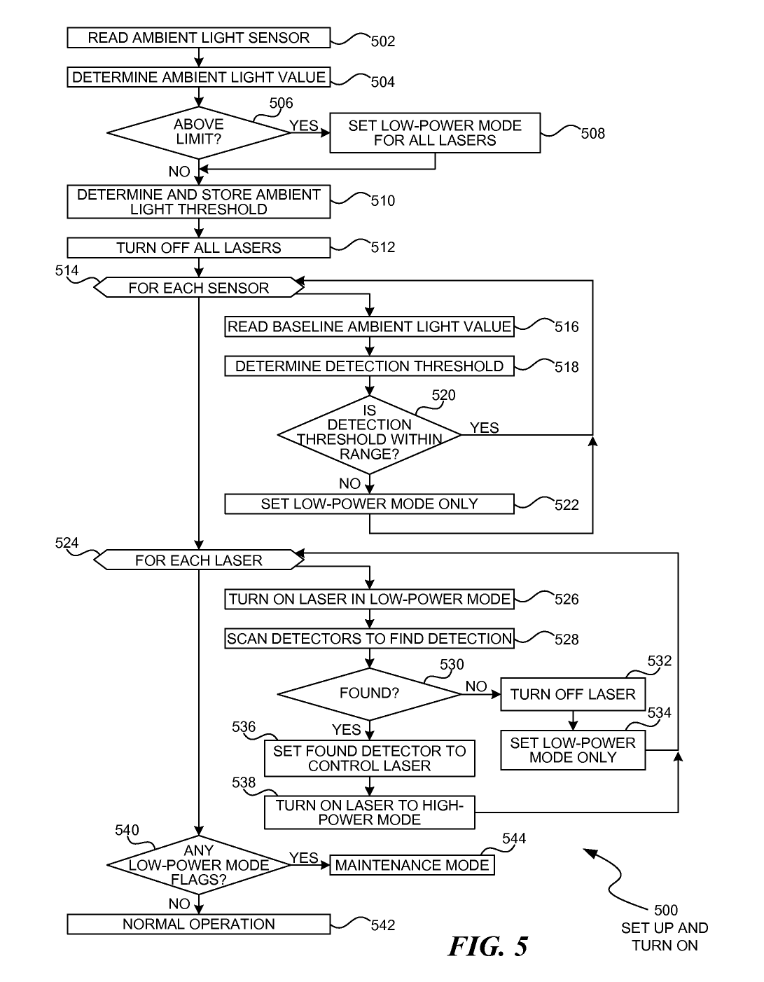

FIG. 5 is a flowchart illustration of an embodiment 500 showing one example of a method for setting up and turning on lasers in a laser detection system.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 500 illustrates a method for setting up and turning on lasers for a laser detection system. The embodiment performs some functions without the lasers turned on to determine ambient light and set various thresholds. If the ambient light levels are suitable, each laser is turned on at a low power mode. If the laser is sensed, the laser may be turned to a high power mode. The low power mode may be a mode where the laser light may be at or below a safe level, such as Class 1 or Class 2 lasers. The low power mode may be any power level that is higher than the safe level, such as Class 2, Class 3B, Class 3R, and even Class 4 in some embodiments.

The embodiment uses an ambient light sensor for determining a baseline ambient light value. The ambient light sensor may be read in block 502 and the ambient light value may be determined in block 504. If the ambient light value is above a predefined limit in block 506, the lasers may be set to only low power mode in block 508.

The predefined limit in block 506 may be a value set of the system that may indicate that too much ambient light is present for effective sensing of the laser beams. When an excess of ambient light is present, the lasers may be operated in a low power mode which may be safe for human interaction.

An ambient light threshold may be determined and stored in block 510. During operational mode, a change to the ambient light threshold may cause the detection thresholds of the detectors to be changed and may also cause the system to exit operational mode if the ambient light rises too high.

In block 512, all of the lasers may be turned off. Each sensor may be processed in block 514 to read a baseline ambient light value in block 516 and determine a detection threshold in block 518. In block 520, the detection threshold may be compared to a range of acceptable detection thresholds. If the detection threshold is within range in block 520, the process may continue with another sensor. If the detection threshold is outside of the range, the lasers may be operated in low power mode only in block 522.

The process of blocks 512 through 522 cycles through each sensor and adjusts the detection threshold based on a baseline ambient light detected by the sensor. This process allows the detection threshold to be a function of baseline ambient light, so that sensors that are exposed to high ambient light may have a higher threshold for determining that a laser beam is present, while sensors that are exposed to low ambient light may have a low threshold. In some embodiments, lower thresholds may provide a more sensitive or accurate detection while higher thresholds may be less sensitive or accurate.

In block 524, each laser may be processed and turned on. The laser may be turned on in low power mode in block 526 and the detectors may be scanned in block 528 to find a sensor that detects the laser. If the laser is not found in block 530, the laser may be turned off in block 532. In some embodiments, the laser may be set to low power mode only in block 534.

If the laser is found in block 530, the detector that sensed the laser may be set to control the laser in block 536 and the laser may be turned to high power mode in block 538.

The process of blocks 524 through 538 illustrate a method for turning on the lasers by first using a safe power level and, when the laser is affirmatively sensed, advancing the laser to a higher power level. The process also allows for a scan of the detectors to determine which of the detectors may be used to control a laser. In some cases, a single detector may be used to detect and control two or more lasers, such as in embodiment 200.

The process of scanning each detector may involve querying each detector to see if the detector senses a light value higher than the detection threshold set in block 518. If the detector senses significantly more light due to the laser having been turned on, the detector can be assumed to be receiving a laser beam from the laser.

Because each detector may be scanned, the process may allow a newly configured system to automatically determine which lasers are pointing to which detectors. Such a feature may be useful in an application where many lasers and detectors are used, and may simplify installation and wiring of the system.

In some embodiments, the scanning operation may identify a laser and detector pair, where the detector senses a laser beam created by the laser. The detector may be used to control that particular laser. In some embodiments, the laser-detector pair may be verified against a predefined list of expected laser-detector pairs. The verification may check that the lasers and detectors are properly configured and positioned as expected.

If any of the lasers are set to low power mode in block 540, the system may enter a maintenance mode in block 544. Maintenance mode may be an operational mode where a technician may align lasers to sensors or perform other operations that may enable the normal operational mode.

If no low power mode lasers exist in block 540, the process may enter normal operational mode in block 542. An example of a normal operational mode is presented in embodiment 600.

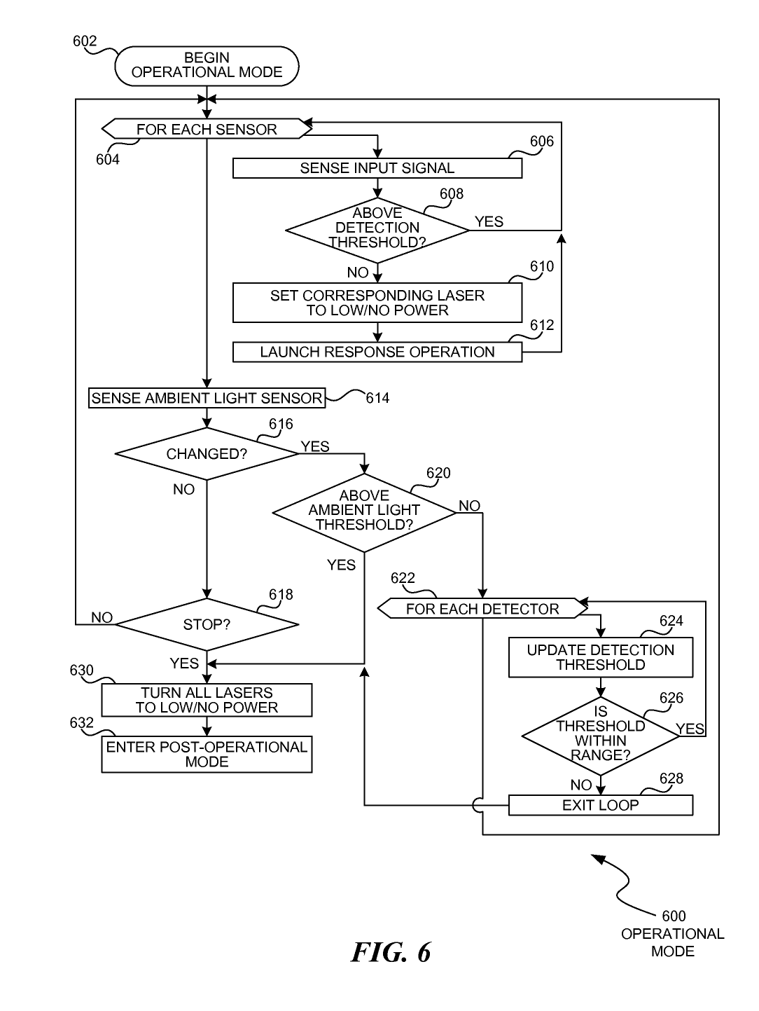

FIG. 6 is a flowchart illustration of an embodiment 600 showing an example of an operational mode of a laser detection system. Embodiment 600 may be one example of a process that may be performed as block 406 of embodiment 400.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

The operational mode of embodiment 600 illustrates a method by which lasers may be operated at high power levels but provide several safety mechanisms that may allow a system to be classified as safe as a lower power level laser system.

Embodiment 600 may be entered after successfully completing a process such as embodiment 500 that permits lasers to be operated in high power mode only after the lasers were properly sensed in a low power mode. When embodiment 500 is successfully completed, the lasers may transmit a laser beam that is affirmatively detected by a detector. In such a state, a human cannot be exposed to the laser beam because each laser beam is being received by a detector.

Embodiment 600 operates by detecting if a laser beam has been broken and shutting off the corresponding laser or setting that laser to a low power level. Additionally, if ambient light has changed, the detection thresholds for each sensor may be updated. Based on the change in ambient light, the process may be exited if the ambient light causes a threshold value to be exceeded.

Operational mode may begin in block 602.

For each sensor in block 604, the input signal may be sensed in block 606 and if the signal is above the detection threshold in block 608, the process may return to block 604. When the signal is above the detection threshold in block 608, the detector senses that the laser beam is present.

If the signal is below the detection threshold in block 608, the corresponding laser may be set to low power or no power in block 610 and a response operation may be launched in block 612. A response operation may alert a security guard in an example of a security system, or in the example of a laser maze, the response operation may cause a light to flash, a noise to be made, and a user's score to be changed.

The process of blocks 604 through 612 may be performed quickly so that the time from detection of a laser beam break to turning off the laser or causing the laser to enter a low power mode is 0.25 seconds or less. In some cases, the timing may be 0.5 seconds, 0.4 seconds, 0.3 seconds, 0.27 seconds, 0.2 seconds, or 0.1 seconds.

In many embodiments, the timing of detecting a laser beam break and turning off the laser may be a factor in ensuring the safety of the system. In some such embodiments, the operations of blocks 604 through 612 may be performed by hardware circuits or by processors that have dedicated processing availability. In some embodiments, a separate hardware circuit or processor may be used for controlling each laser or for controlling a limited number of lasers. Such embodiments may operate in a continual monitoring mode once the lasers are set to high power mode, and may monitor multiple detectors in parallel.

In block 614, the ambient light detector may be sensed. If the ambient light has not changed in block 616 and there is no other reason to exit operational mode in block 618, the process may return to block 604.

If the ambient light has changed in block 616, and the ambient light is above an ambient light threshold in block 620, the detection thresholds for the sensors may be adjusted using the process of blocks 622 through 628.

In block 622, each detector may be evaluated. For each detector, the detection threshold may be updated in block 624 based on the change in the ambient light of block 614. If the threshold is within a predetermined range in block 626, the process may return to block 622.

If the threshold is outside of a predetermined range in block 626, the ambient light has saturated the detector such that the detector may not be able to discriminate between the laser beam and ambient light. In such a case, the loop of block 622 may be exited in block 628 and all lasers may be turned to a low power or no power mode in block 630. Such an exit may be an unexpected or emergency exit of normal operations. After the lasers are turned to a safe mode in block 630, the process may enter a post-operational mode in block 632.

The process may enter the post-operational mode by exiting the loop of block 618. In some embodiments, the detection of a single laser beam being broken may cause the normal operations to cease. In other embodiments, several or even all of the laser beams may be broken without causing normal operations to be exited.

The decision to exit normal operations in block 618 may be caused by an outside action, such as a signal to exit from a user or other device.

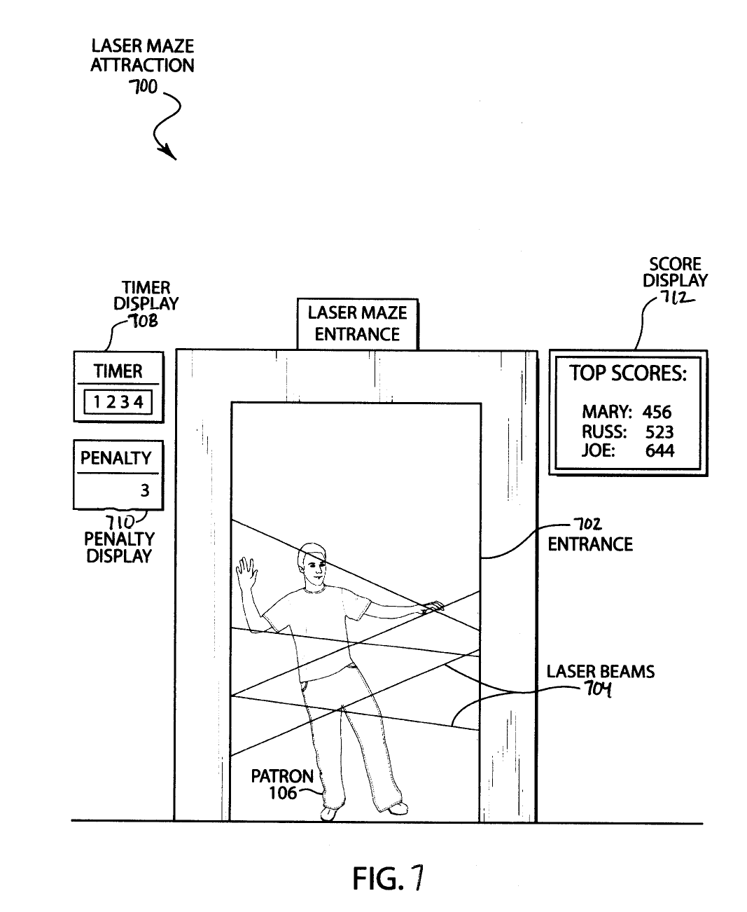

FIG. 7 is a diagram of an embodiment 700 showing a laser maze attraction. A laser maze attraction may have a series of laser beams that are oriented across a path which a patron attempts to follow without breaking the laser beams. Each laser may direct a beam to a sensor that can detect if the beam has been broken. The attraction may be operated so that the patron receives a score that is a combination of the time required to navigate the path with a penalty for each beam that is broken. Other effects, such as lights, sounds, and motions may be added to the attraction and may be caused to operate with certain events or when a laser beam is tripped.

The embodiment 700 shows an entrance 702 to a laser maze having several laser beams 704 and a patron 706 attempting to navigate the laser maze. The laser beams 704 may be oriented in any manner within the laser maze in order to produce obstructions to the path of the patron 706. In many embodiments, a fog generator may be used to make the laser beams visible to the patron 706.

The laser beams 704 may be oriented so that the patron may step across the beams, duck under the beams, slide to the side of a beam, crawl underneath, or otherwise contort and slither through the maze.

A timer display 708 may indicate a time or score based on the time the patron takes to traverse the path. In some instances, the timer may use real time indicator, such as counting minutes and seconds. In other instances, the timer may use a non-real time indicator, such as a number of processor counts or other time indicator.

A penalty display 710 may indicate the number of broken laser beams or a penalty associated with the number of broken laser beams. Each embodiment may have a different method for assessing a penalty for broken or tripped laser beams. Some embodiments may calculate a final score that incorporates the patron's time and any penalty for tripped laser beams. For example, a score calculator may include the patron's time in seconds plus a ten second penalty time for each laser beam that is broken.

Some embodiments may use different colored lasers, with each color having a different penalty assigned. For example, green and red lasers may be present, with red lasers having a 10 second penalty for each broken beam while assessing a 5 second penalty for breaking a green laser beam.

In some embodiments, a graduated penalty may be calculated. For example, when one beam is broken, a 10 second penalty may be added to the score but when two beams are broken, a 15 second penalty may be assessed.

In other embodiments, a score may be determined using the configuration of the laser maze. For example, some lasers in certain portions of a maze may have higher penalties than other lasers. The number of methods for calculating a score using a combination of time and tripped laser beams is infinite and may vary with the designer of a maze.

Some embodiments may combine a time and penalty for broken laser beams into a single score for each attempt by a patron. In other embodiments, the score and penalty may be tracked and recorded separately to yield a two-part score.

A score display 712 may be updated to show various data about patron scores for the attraction. In some cases, the top scores may be shown with a patron's identification. In other cases, the last several scores may be listed. The display 712 may also be used to display the rules of the attraction, how a score is calculated, advertisements for the attraction or other items, camera views of a patron in the maze, real time score for the current patron, or other information. In many cases, the display 712 may change from one screen to another showing top scores, recent scores, or other information.

In some embodiments, some or all of the timer display 708, the penalty display 710, and the score display 712 may be visible to patrons standing in line to use the attraction or may be visible to the patron 706 who is traversing the maze.

Some embodiments may have several different configurations of laser beams that may be used to obstruct a path. For example, an easy version of a maze may have a subset of the entire set of lasers operational, while a difficult version of the same maze may have the entire set of lasers illuminated. Different point values or scores may be assessed for each version of the game.

Some embodiments may have different sets of lasers operational to create a different challenge for each patron. In an example of such embodiments, each patron may be challenged with one of three subsets of laser beams. Another example may illuminate a random set of lasers so that each traversal of the maze is a different experience or challenge for the patron.

The laser maze may include additional challenges of mind or skill as part of the attraction. For example, a patron may traverse a portion of a maze then encounter a puzzle or other challenge to solve. After solving the puzzle, the patron may traverse another section of the maze or move to another interactive element of the maze.

In some embodiments, the laser maze may be coupled with other elements involving other patrons. For example, a laser maze may be installed as a minefield or challenge within a laser tag or paintball competition arena. In such an embodiment, multiple patrons may be armed with a laser gun and receiver vests or paintball guns and seek out and shoot other patrons, play capture the flag, or other contests. Such embodiments may group patrons into teams or may be an individual contest.

A laser maze may be installed in a particular area of the play zone as a challenge to negotiate. For example, in a capture the flag contest, a laser maze may be installed in a passageway through which a patron may negotiate to reach the competitor's flag. Such an installation may calculate a penalty score for tripping a laser beam in determining an eventual winner of the contest. Additionally, tripping a laser beam may trigger a noisemaker, lights, or cause some other event to occur that alerts patrons that someone is attempting to capture a flag.

Some embodiments may be designed so that two or more patrons may traverse a single maze together. Other embodiments may allow two patrons to simultaneously race each other in similar but separate mazes. In some embodiments, a two person maze may include two separate buttons at a point in the maze. The buttons may be placed a distance apart from each other so that one patron cannot reach both buttons. As part of the maze, both buttons may be pressed simultaneously to indicate that the two patrons had completed a section of the maze.

A laser may be controlled such that when the laser beam is broken, the laser is turned off. By turning off a laser when the beam is broken, a patron may be protected from having a laser beam shine directly into the patron's eye. Further, the patron will be instantly notified that the beam has been broken. In other embodiments, a laser may flash or pulsate when the beam is initially broken and may turn off completely when the beam is broken for an extended period of time. In still other embodiments, a tripped laser may be displayed at a low power setting. Some embodiments may actuate a noisemaker, light, movement actuator, or other device when a laser is broken.

In some embodiments, a laser may stay illuminated or may pulse when the beam is initially broken. In such an embodiment, a small penalty may be assessed for breaking a beam for a short period but a larger penalty may be assessed for breaking a beam for a longer period.

Some embodiments may determine that a laser beam is broken when a sensor device receives a signal below a specific threshold. Other embodiments may be constructed so that the signal strength received by the sensor may be used to determine a penalty. For example, when a patron brushes up against a laser beam, the laser beam may be partially blocked but not completely blocked. The sensor may be calibrated to sense the partial blocking. The partially blocked beam may be used to assess a partial penalty, illuminate a warning signal, cause the beam to pulsate, or perform some other action.

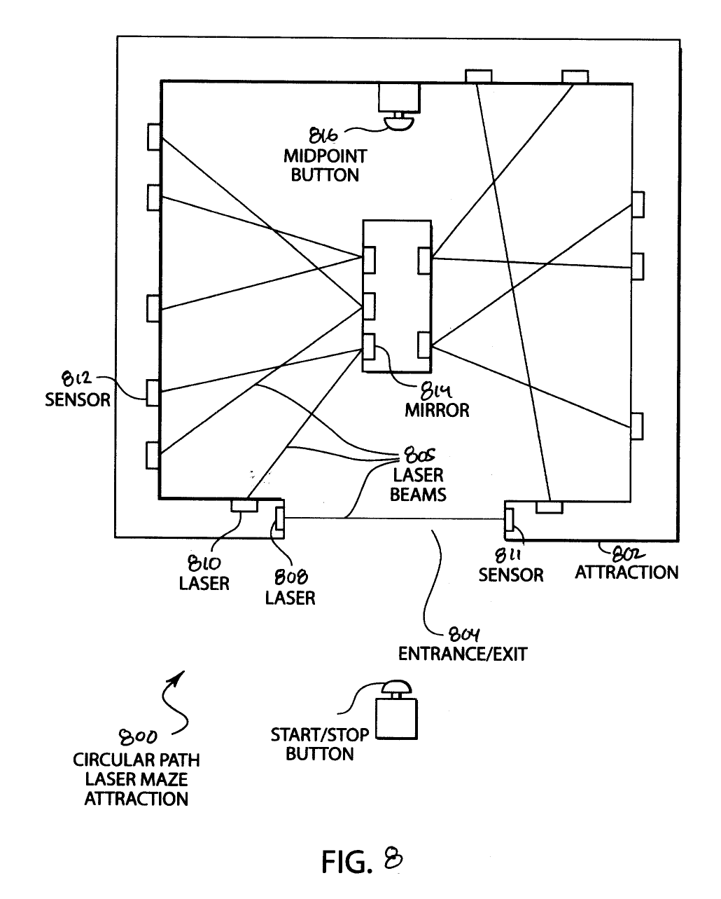

FIG. 8 is a plan view of an embodiment 800 showing a laser maze attraction with a circular pathway.

The laser maze attraction 802 has a combined entrance and exit 804. A start/stop button 806 may be used to start and stop a timer. A patron may press the start button 806, traverse the maze, press the midpoint button 815, traverse the maze again, and press the start/stop button 806 to finish the maze.

A laser maze attraction may be configured on any type of path, including circular paths having a combined entrance and exit, serpentine or tortuous paths having a separate entrance and exit, straight paths, or any other shaped path. In such paths, lasers may be oriented in any position that may provide a partial obstacle to the path. Lasers may be positioned to force a patron to twist, crawl, step over, duck under, or otherwise maneuver around the laser beams.

A laser 808 and sensor 811 may form one of the laser beams 805 across the entrance/exit 804 of the attraction 800. Another laser 810 may form two beams by bouncing from the laser 810 to the mirror 814 and to the sensor 812. Other embodiments may use multiple mirrors, prisms, beam splitters, or other devices to create different beam configurations and effects.

In many attractions, laser beams may be turned on in sequence. For example, a patron may progress through a portion of a maze path to a first point, have their presence sensed by a sensor, and have additional lasers illuminated ahead in the path.

Another type of sequence may be for one, two, or more lasers to be turned on and off for a designated time. For example, three lasers beams may be mounted as sequential obstacles across a path. The three laser beams may be sequenced so that the first beam turns off, then the second, then the third, allowing a patron to pass through the sequence of laser beams. In some such embodiments, the laser beams may turn on in the same sequence, and the process may be repeated. Such an embodiment may act as a gauntlet, enabling a patron to pass by following the sequence of laser beams.

In some cases, one or more laser beams may be turned on or off when another laser beam is tripped. For example, after breaking a first beam, additional laser beams may be turned on to provide additional obstacles, while other lasers may be turned off. Each attraction may use different logic to provide different challenges to a patron.

The various lasers, sensors, and mirrors may be mounted in the attraction 202 in any useful manner. In some cases, the various components may be rigidly mounted in a wall of an attraction. In other cases, one or more of the components may be mounted using a stand, mounted in a scenery object, or some other mounting mechanism.

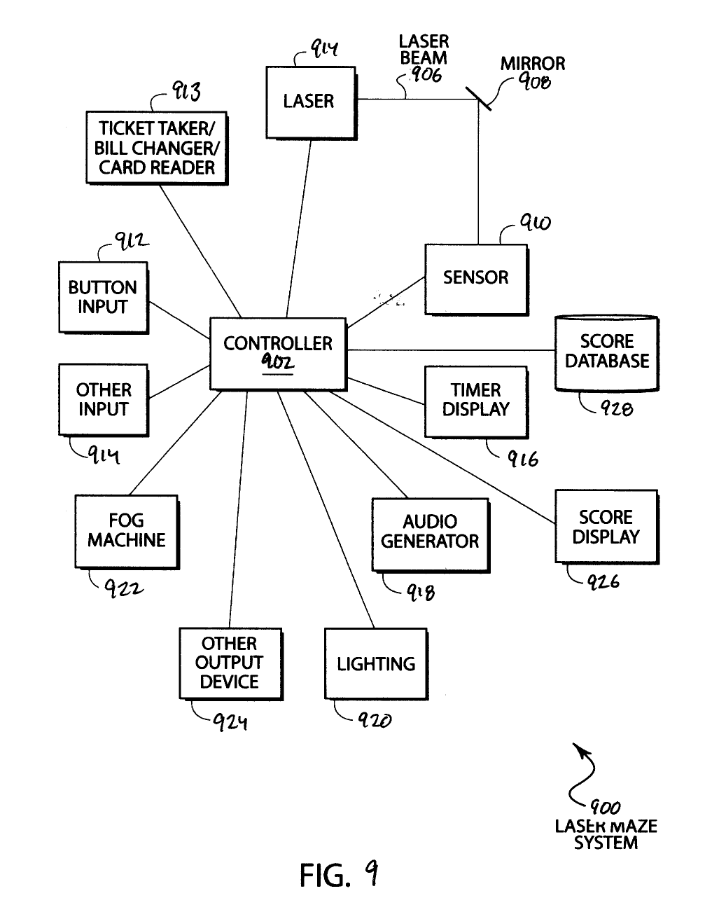

FIG. 9 is a diagram of an embodiment 900 showing various components that make up a laser maze system. A centralized controller 902 may perform many operations for a laser maze attraction.

The controller 902 may control multiple lasers 904 that produce a laser beam 906. The laser beam 906 may be reflected by one or more mirrors 906 and received by a sensor 910. The controller 902 may be able to turn the laser 904 on and off and receive a signal from the sensor 910.

In some embodiments, the controller 902 may be able to cause the laser 904 to pulsate, operate in sequence with other lasers, adjust intensity, or cause other changes in the laser output.

The controller 902 may be able to receive a signal from the sensor 910 to determine if the laser beam 906 has been broken. In some instances, the signal from the sensor 910 may be an on/off or single bit digital signal, while in other instances, the signal may be an analog signal or a multi-bit digital signal that has multiple values.

When a controller 902 may receive an analog or variable signal from a sensor 910, the controller 902 may be able to process the signal using a threshold to determine if the beam is broken or not. In some cases, a variable signal may be used to calculate penalties based on how much of the beam has been broken, in contrast to other cases where a penalty is assessed when the beam is completely broken.

The controller 902 may use various other inputs, such as a button input 912 or other inputs 914 to perform various actions such as starting and stopping timers, sequencing the game play, and other functions. In some cases, various inputs may be used to turn on and off the laser 904.

The controller 902 may produce various outputs to control various devices. During gameplay and after a patron has completed traversing the attraction, a timer display 916 may show a current score, a top time, or other information relating to a game in progress or a recently completed game.

Before, during, and after gameplay, various other output devices may be actuated. For example, an audio generator 918 may play noises or sounds continually. Additionally, special sounds may be played when a laser beam is broken or in response to other events, such as starting or stopping a game, achieving a high score, or some other event. Similarly, a lighting device 920 may be actuated in response to various inputs.

Other output devices 924 may include mechanical actuators, air jets, or any other controllable device. The controller 902 may be able to control any output device using any type of input.

The controller 902 may have various input and output devices for capturing and displaying information about patrons. In some cases, a patron's score may be captured, stored, and tracked. Various input devices may be used to identify a particular patron. For example, a keyboard or other input device may be used to type a patron's name, alias, or other identifier.

In another example, a patron may be issued a wristband with a barcode identifier that is stored in a score database 928. When the patron uses the attraction, a barcode scanner may scan the wristband and the controller 902 may store the patron's score in the score database 928.

The controller 902 may be able to calculate a score for each use of an attraction. A history of scores may be stored in the score database 928, which may be used to determine a ranking of scores over a period of time.

In some embodiments, a contest may be held wherein a prize may be awarded for the best score over a period of time. Each patron's scores may be stored in the score database 928 and a winner may be determined over a period of time. In some instances, the period of time may be a single day or afternoon, while other instances may track scores over a period of days, weeks, or months to determine a champion.

The score database 928 may be stored in a nonvolatile memory system such as a hard disk. In some instances, the score database 928 may be located through a network connection, such as on a remote server that may be connected through the Internet.

For the purposes of this specification and the claims, a controller may be a single processor controller or a combination of multiple processors. In some cases, a portion of the functions of a controller may be performed by one processor, programmable logic device, gate array, logic device, state machine, ladder logic controller, personal computer, microprocessor, hardwired logic device, or other controller element while other functions are performed by a different controller element. For example, a personal computer may be used to perform some functions such as a user interface or network connectivity while another controller element with a separate processor performs the laser control and sensing functions. The ‘controller’ as used in this specification and claims may be of any architecture adapted to perform the functions described. Any reference to a controller architecture is for illustrative purposes and is not meant to be limiting.

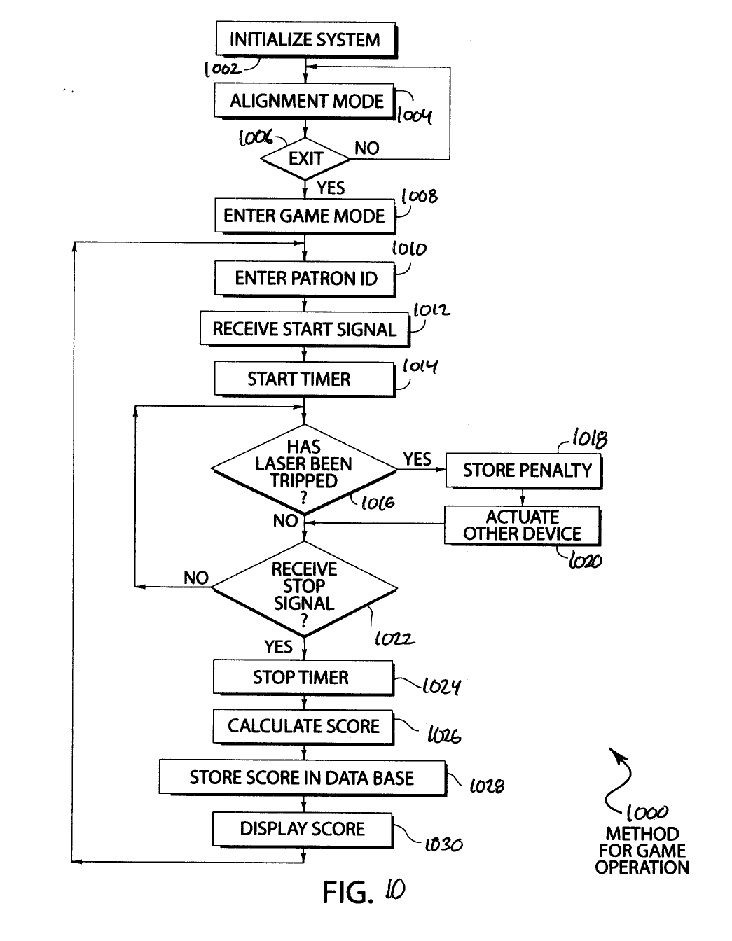

FIG. 10 is a flowchart illustration of an embodiment 1000 showing a method for game operation. The method illustrates an alignment mode and a game mode.

The system is initialized in block 1002 and may enter an alignment mode in block 1004. In an alignment mode, each laser may be illuminated and may enable a technician to align a laser beam to strike a sensor. During alignment mode, the controller may keep the lasers illuminated even when the sensor does not receive a signal. The alignment mode may also include a display that may indicate whether each sensor is picking up a signal and may also indicate the signal strength in some embodiments. Such a display may be also used as a top score display during normal operation. Another embodiment of such a display may include LED or other indicators near the sensors or in some other location such as LEDs located on a controller board used for electrical connections.

In some embodiments, alignment mode may be entered automatically during an initialization phase. The alignment mode may be used to verify that each sensor is receiving a signal from the proper laser and that the lasers, mirrors, beam splitters, or other optical component are properly aligned so that the laser beam reaches the sensor.

In other embodiments, alignment mode may be a form of a maintenance mode of a controller. Alignment mode may be entered by using a special code, key switch, or other input signal that may be controlled by a technician. In some embodiments, alignment mode may be entered by pressing a switch or actuating a button in an electrical cabinet or a secret or inaccessible location so that patrons do not have access.

The game mode is entered in block 1008.

A patron identification may be entered in block 1010. In some embodiments, the patron identification may be added after the patron has finished the maze, while in other embodiments, the identification may be entered prior to entering the maze.

The patron may be identified using any type of device and in any manner. In some embodiments, a computer terminal with a display and keyboard may be used to enter a patron's identification. When a database is used with the attraction, a returning patron's identification may be selected from previous entries in the database.

In some instances, a patron's identification may be entered into a database prior to a first use of the laser maze. A patron may then select their identification from the available patron identifiers in the database.

A patron's identification may be any unique identifier. For example, an email address, name, social security number, alias, personal identification number, or any other identifier may be used, depending on the embodiment.

A start signal is received in block 1012 and a timer is started in block 1014. The start signal may be any input that may be used to start a timer. In the embodiment 800, a start/stop button may be used to initiate the timer. Such a button may be pressed by a patron or by an attraction operator. Other input devices, such as a sensor, may also be used to sense the patron's presence in a designated area and begin the timer.

The timer may use real time, such as minutes and seconds, to count up or down while a patron traverses the maze. Other embodiments may use a timer that does not count in real time but uses processor counts or some other timing mechanism.

While the timer is running, a patron may be attempting to navigate the laser maze and avoid tripping any laser beams. If a laser beam has been tripped in block 1016, a penalty may be stored in block 1018 and another device may be activated in block 1020.

A penalty may be determined in many different ways. In a less complex example, each tripped laser beam may result in a single penalty. When a score is computed, the score may be adjusted based on the number of penalties. In more complex embodiments, different penalties may be assessed for different actions. For example, breaking a beam of one color may be assessed a different penalty than breaking a beam of a different color. Many variations of penalties and calculating penalties may be used.

When a laser beam is tripped, another device may be activated in block 1020. For example, an air jet may be fired in the direction of the patron, a noise may be played, or a light may be flashed. In some embodiments, a mechanical actuator may be actuated to move a prop or other device within the maze.

In some embodiments, tripping a laser may change the gameplay by illuminating or turning off some lasers. For example, tripping one laser may cause another laser to be illuminated in the path of a patron, adding to the difficulty. In another example, tripping a specific laser beam may cause other lasers to turn off, lowering the difficulty and possibly lowering the potential score a patron may achieve, depending on how a score may be calculated.

If a stop signal is received in block 1022, the timer is stopped in block 1024, otherwise the process loops back to block 1016. A stop signal may be any type of input device or sensor that is used to stop the gameplay. In the embodiment 800, the start/stop button may be pressed by a patron upon exiting the attraction to stop the timer.

After the timer is stopped in block 1024, a score may be calculated in block 1026. The score may be calculated in any manner. In some instances, a score may consist of a time plus any penalties for tripping laser beams. In such an instance, a lower score may be more desirable than a high score. In other instances, a score may consist of a time plus a separate variable for penalties.

In still other instances, a score may be computed based on time, difficulty, which laser beams were tripped, and other inputs, such as a score for completing a puzzle or some other variable input. In some cases, a score computation may make a higher score more desirable than a low score.

The score may be stored in a database in block 1028 along with the patron identification. In some embodiments, the database may be volatile and may be reset when the attraction is reset. In other embodiments, the database may be nonvolatile and may be stored on a hard disk or a remote computer or server.

The score may be displayed in block 1030. In some embodiments, a score may be displayed with other scores, such as a top three list, the last several patron's scores, or the last several scores for the patron. The scores may be displayed in many different manners on many different types of displays.

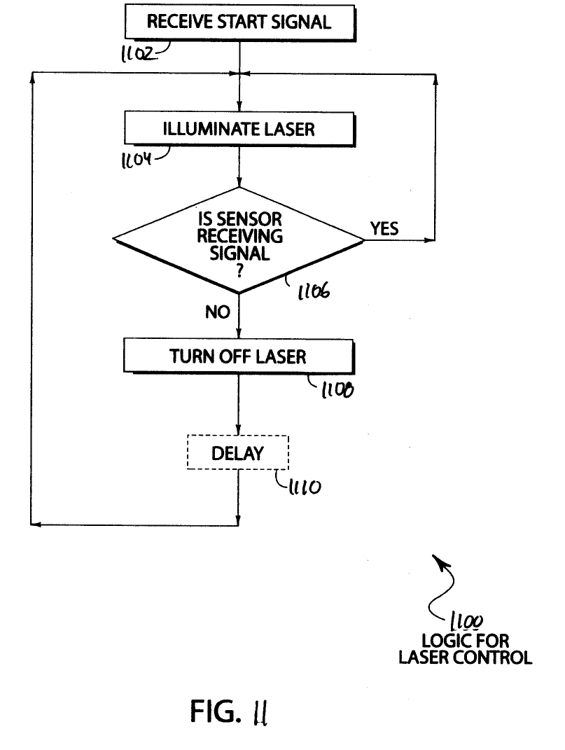

FIG. 11 is a flowchart illustration of an embodiment 1100 showing a method for controlling a laser during a game mode of a laser maze.

After receiving a start signal in block 1102, the laser is illuminated in block 1104. While a sensor is receiving the laser beam and generating a signal in block 1106, the process loops. When the sensor stops receiving a signal in block 1106, the laser is turned off in block 1108.

Embodiment 1100 illustrates a logic that may be employed to control a laser. The logic has several features. First, because the laser may be shut down immediately when the beam is interrupted, any damage to the eye of a patron may be prevented. Second, the visible disappearance of the laser beam may indicate to the patron that the beam has been tripped and that the patron incurred a possible penalty.

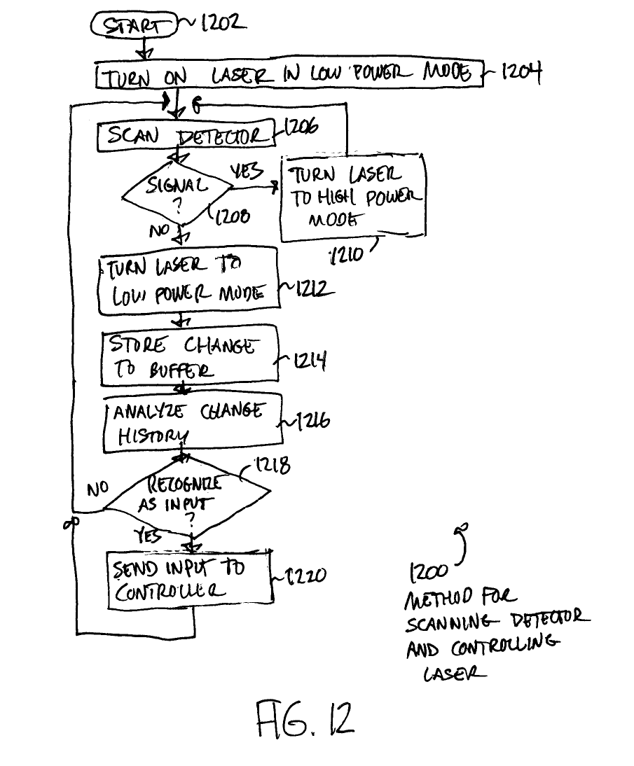

FIG. 12 is a flowchart illustration of an embodiment 1200 showing a method for controlling a laser using multiple breaks of the laser beam as an input.

Embodiment 12 illustrates one input mechanism that may be used to detect various inputs to a controller. Specifically, a laser beam may be broken multiple times in short succession to indicate a specific input. In one type of activation, a user may pass two, three, or more fingers across the laser beam in quick succession. The user may, for example pass an opened hand with three outstretched fingers across the laser beam. In another example, a user may repeatedly pass a finger or hand through the laser beam.

The action of breaking and reconnecting the laser beam may be used as an input in many different manners. As will be illustrated below, the input may be used as part of a maintenance mode to select which lasers are to be turned on during gameplay. Such a use may be for configuring a game prior to play. In another manner, a patron may use the method of embodiment 1200 to enter data to the controller, which may be used to change the game configuration or for some other uses.

Embodiment 1200 illustrates a mechanism where a laser beam may be broken, then operated in a low power mode while the laser beam is broken. When the laser beam is detected again, the laser beam may be returned to high power mode.

Each time the laser beam may be broken and restored, the change may be stored in a buffer. The buffer may contain entries for the last several times the beam has been broken or restored. When the buffer contains a certain number of laser cycles within a certain period of time, the input may be determined and processed by a controller.

The process may start in block 1202.

A laser may be turned on in low power mode in block 1204. The detector for the laser may be scanned in block 1206. If there is a signal in block 1208, the laser may be turned on in high power mode in block 1210.

The operations of blocks 1204 through 1210 may represent a similar operation as embodiment 500. Embodiment 500 provides a much more detailed sequence of a startup routine.

When the laser is not detected in block 1208, the laser may be turned to a low power mode in block 1210. In some embodiments, the timing of steps 1208 and 1210 may be fast enough that a laser may be switched to a Class 1 power level before causing damage to a human retina, as described above.

The change may be stored in a buffer in block 1214. In one embodiment, the buffer may contain timestamps for each time the laser was toggled on or off. Other embodiments may use other mechanisms for tracking when the laser beam was broken.

The change history may be analyzed in block 1216 to determine if the change meets predefined criteria for an input. If the change does not register as an input in block 1218, the process may return to block 1206. If the change does register as an input in block 1218, the input may be transmitted to a controller in block 1220.

The criteria for sensing an input may be a certain number of breaks of the laser beam in a certain period of time. For example, one criteria may be six beam breaks within two seconds. Other criteria may be two beam breaks within three seconds.

The criteria may be set more or less stringent depending on the situation. In the case of a maintenance mode operation of embodiment 1400 presented later in this specification, a more stringent criteria may be used to minimize accidentally indicating an input. In the case of gameplay operation of embodiment 1500 presented later in this specification, a less stringent criteria may be used so that accidental tripping may help the user uncover a game secret.

The criteria may be selected so that a person may make several motions with a hand, foot, or other extremity to break the laser beam several times. The user may have an article in their hand, such as a baton, stick, or other item that may be used to break the laser beam. Such criteria may be to break the beam quickly and intentionally using a manual motion.

Examples of such criteria may be to have more than one break of the beam within two seconds. For instances where accidental beam breaking is to be avoided, such as in a maintenance mode, a criteria may be for 4, 5, 6, or more breaks within a few or several seconds.

Some embodiments may count the number of breaks in a certain timeframe and use the number as data associated with an input. Examples may include counting the number of beam breaks within 1, 2, 3, 4, 5, or more seconds. One use may be for the user to go as fast as possible to break the beam as many times as possible in order to get a bonus score in gameplay. A user may be able to break a beam many tens or hundreds of times within a period of several seconds.

The criteria may range from 2 beam breaks within a short period to 5, 10, 15, 20, or more breaks within 1, 2, 3, 4, 5, 10, 15, 20, or more seconds.

The criteria may set both a maximum and minimum amount of time for detecting. A maximum time may count the number of beam breaks over the preceding amount of time. The maximum time may be in the millisecond range, such as 10, 20, 50, 100 ms, may be in the seconds range, such as 1, 2, 3, 5, 10, 30 seconds, or may be in the minute range, such as 1, 2, 3, 5, 10 or more minutes.

A minimum time may define that may separate each beam break or the minimum length of time for a beam break to be registered. For example, the minimum time may specify that the time a beam is turned off is 50 ms and detected for 75 ms for a specific input. The minimum time may be in the millisecond range, such as 10, 20, 50, 100 ms, may be in the seconds range, such as 1, 2, 3, 5, 10, 30 seconds, or may be in the minute range, such as 1, 2, 3, 5, 10 or more minutes.

The number of breaks in order to register an input may vary from 2 breaks, to 3, 4, 5, 6, 7, 8, 9, 10, 12, 15, 20, or more breaks over a period of time.

Some embodiments may identify different inputs based on different numbers of breaks. For example, a sequence of three breaks within a period of time may indicate one command while another sequence of four breaks within the same period of time may indicate a second command.

In one example of a maintenance mode, a sequence of 5 breaks within 2 seconds may indicate that a laser is selected for removal, while a sequence of 7 breaks within 2 seconds may indicate that the current configuration may be reset.

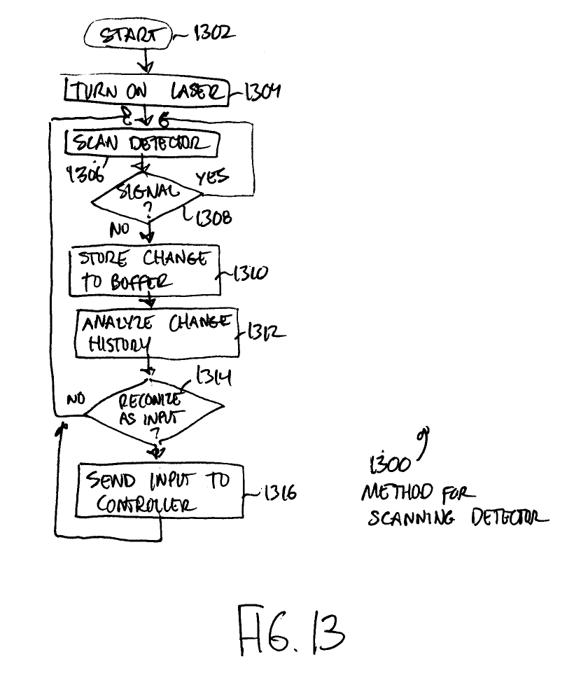

FIG. 13 is a flowchart illustration of an embodiment 1300 showing a method for scanning a detector.

Embodiment 1300 illustrates a mechanism where a laser beam may be broken and an input determined by the number of breaks within a period of time. Embodiment 1300 may operate in a similar manner as embodiment 1200, except that the laser may be on continuously at the same power level even though the beam is broken.

For laser maze attractions, embodiment 1300 may be used with Class 3 lasers provided the user has protective eyewear during operation.

The process may start in block 1302.

A laser may be turned on in block 1304. The detector for the laser may be scanned in block 1306. If there is a signal in block 1308, the process may loop back to block 1306.

If no signal is detected in block 1308, the change may be stored to a buffer in block 1310 and the buffer may be analyzed in block 1312. If the buffer analysis identifies an input in block 1314, the input may be sent to the controller in block 1316. Otherwise, the process may loop back to block 1306.

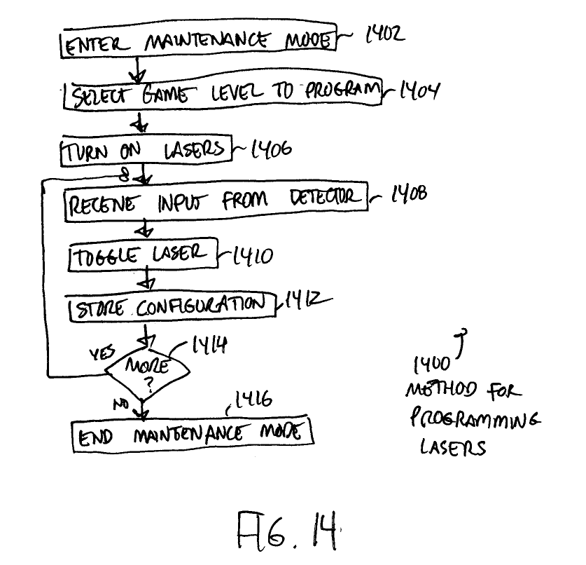

FIG. 14 is a flowchart illustration of an embodiment 1400 showing a method for programming lasers.

Embodiment 14 illustrates one sequence that may be used in a maintenance mode to program a controller. In many laser maze games, there may be several levels of play. A hard level may have more laser beams than an easy level, some levels may have some laser beams that other levels do not.

In order to program a controller, the laser maze may be operated in a maintenance mode that recognizes input from a user. The user may be a technician who enters the maze with the lasers illuminated and selects which lasers are on or off for certain levels.

The technician may select individual lasers by waving a hand or fingers quickly through the beam several times to select the laser. Once selected, the technician may store the configuration for use during a specific level of play.

In block 1402, maintenance mode may be entered.

The game level to program may be selected in block 1404. For example, the levels may be easy, medium, and hard. For the harder levels, the lasers that make the game more difficult may be selected, while easier levels may have fewer lasers or lasers that make the game simpler.

All of the lasers may be turned on in block 1406. The technician may select various lasers by waving a hand or fingers across a specific laser beam in block 1408, which causes an input to the controller. Based on the input created by waving the hand across the laser, the laser may be toggled in block 1410 from selected to unselected.

In some embodiments, the laser may be toggled off when selected. In such embodiments, the laser may be turned off and thus unable to illuminate a detector or sensor. Such embodiments may provide the technician with a flashlight or portable laser, and the technician may wave the flashlight or portable laser across the detector in sequence to cause another input to the controller. The controller may then toggle the laser back on.

After changing the configuration of the lasers in block 1410, the configuration of the lasers may be stored in block 1412. If more changes may be made in block 1414, the process may return to block 1408. If no more changes are to be made in block 1414, maintenance mode may end in block 1416.

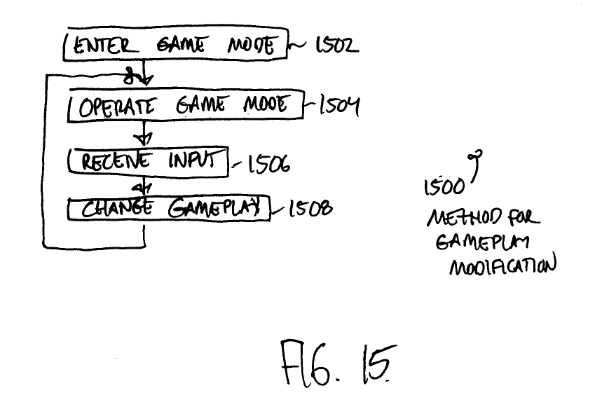

FIG. 15 is a flowchart illustration of an embodiment 1500 showing a method for using an input command during gameplay.

Embodiment 15 illustrates one sequence that may be used in a gameplay mode as an input to the game. A patron may break a beam multiple times using fingers, hands, feet, or other mechanisms to cause an input to occur.

Game mode may be started in block 1502. The system may operate in game mode in block 1504, during which an input may be received in block 1506 by a patron repeatedly breaking a laser beam. The gameplay may be changed in block 1508 as result of the input.

Some embodiments may use the input mechanism to select a level of play. In such an embodiment, the user may pass several fingers through an illuminated laser beam to select a level of play. For example, a user may pass two fingers through a beam for an easy level and four fingers for a hard level.

Other embodiments may use some lasers to open ‘game secrets’. For example, a designated laser in the middle of a maze may be the ‘secret’ laser. A patron may pass several fingers, body parts, or other objects through the ‘secret’ laser several times, causing the game to become much easier or to unlock a special prize or reward.

Some embodiments may allow a user to get a bonus score by breaking a beam very fast. Such embodiments may register the number of breaks in a predefined period of time as a bonus or some other scoring effect.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A system comprising:
a laser transmitter;
a laser sensor;
a controller that:
causes said laser transmitter to transmit a laser beam, said laser beam being oriented to be received by said laser sensor;
detect that said laser beam has been broken and reestablished a first predefined number of times in a first predefined period of time to determine that an input has occurred; and
process said input.

2. The system of claim 1, said input being processed to turn off said laser transmitter.

3. The system of claim 2, said controller that further:
while said laser transmitter is turned off, detect that an input has occurred when a light has been transmitted to said laser sensor and turn on said laser transmitter.

4. The system of claim 3, said light being transmitted to said laser sensor by cycling the light on and off using a second predefined number of times in a second predefined period of time.

5. The system of claim 1, said first predefined number of times being at least three and said first predefined period of time being less than three seconds.

6. The system of claim 1, said input being processed to change said laser transmitter to transmit at a low power.

7. The system of claim 1, said controller that further:
detects that said laser beam is broken and causes said laser transmitter to transmit in a low power mode.

8. A laser maze attraction comprising:
a plurality of laser sensors;
a plurality of laser transmitters, each of said plurality of laser transmitters being configured to transmit a laser beam to one of said laser sensors;
a controller that:
detect that a first laser beam has been broken and reestablished a first predefined number of times in a first predefined period of time to determine that an input has occurred; and
process said input.

9. The laser maze attraction of claim 8, said controller that further:
enters a maintenance mode prior to detecting said first laser beam has been broken; and
as part of said maintenance mode, processes said input to select a laser for a programming step.

10. The laser maze attraction of claim 9, said programming step comprising setting a level of play, said level of play comprising a subset of said laser transmitters being operational at one time.

11. The laser maze attraction of claim 8, said controller that further:
processes said input as part of gameplay, said first laser beam being broken and reestablished by a patron.

12. The laser maze attraction of claim 11, said input being to change at least one laser during said gameplay.

13. The laser maze attraction of claim 12, said controller that further:
detects that said laser beam is broken and causes said laser transmitter to transmit in a low power mode when said laser sensor is not receiving a signal.

14. The laser maze attraction of claim 13, said low power mode being compliant with Class 1.

15. The laser maze attraction of claim 14, said controller that further:
detects said laser beam with said laser sensor and causes said laser transmitter to transmit in a high power mode when said laser sensor is receiving a signal.

16. The laser maze attraction of claim 15, said high power mode being compliant with Class 2.

17. The laser maze attraction of claim 15, said high power mode being compliant with Class 3B.

18. The laser maze attraction of claim 17, said controller changing from said high powered mode to said low power mode within 0.25 seconds after detecting said laser beam is broken.
